(19) United States
(12) Patent Application Publication
(10) Pub. No.: US 2012/0239168 A1
(43) Pub. Date: Sep. 20, 2012

(54) VIRTUAL COMMUNICATION RELATIONSHIP INFORMATION EXTRACTION, AVAILABILITY DETERMINATION AND VALIDATION FROM FOUNDATION FIELDBUS DEVICE DESCRIPTION FILES

(75) Inventors: GURUPRASAD VISHWANATH KARKALA, Hyderabad (IN); ABHIK BANERJEE, Hyderabad (IN); RAGHAVENDRA RAO PERAMPALLI NEKKAR, Hyderabad (IN); PRADYUMNA OJHA, Hyderabad (IN); KIRAN KUMAR SOMAVARAPU, Hyderabad (IN)

(73) Assignee: GENERAL ELECTRIC COMPANY, Schenectady, NY (US)

(21) Appl. No.: 13/049,428

(22) Filed: Mar. 16, 2011

(51) Int. Cl. G05B 9/02

(52) U.S. Cl. 700/78

(57) ABSTRACT

A method for virtual communication relationship extraction, availability determination and validation from a foundation fieldbus device descriptor file can include obtaining a number of virtual communication relationships for fieldbus and linking devices coupled to a host system, identifying types of the virtual communication relationships for the fieldbus and linking devices, configuring function blocks related to the fieldbus and linking devices, reporting a count of consumed virtual communication relationships and available virtual communication relationships for the fieldbus and linking devices, determining an availability of a total number of virtual communication relationships and in response to no availability of virtual communication relationships, generating a message on the host system.

### BACKGROUND OF THE INVENTION

The subject matter disclosed herein relates to industrial automation protocols and more particularly to systems and methods for virtual communication relationship extraction, availability determination and validation from foundation fieldbus device description files.

Foundation fieldbus is a digital serial industrial automation protocol, two-way communication system that interconnects “field” equipment such as sensors and actuators. Foundation fieldbus provides integration of high-speed controllers (having host systems software) (e.g., programmable logic controllers (PLC) and distributed control system (DCS) controllers), H1 device subsystems via a linking device, data servers and workstations. An H1 device is any Intelligent Field device such as temperature transmitters, pressure transmitters, and different types of actuators, which communicate to the PLC or DCS controllers (via a linking device) through Foundation Fieldbus protocols. A linking device is an interface module between the H1 device (e.g.: sensors, actuators etc) and PLC or DCS controllers. The linking device performs various functions such as synchronizing communication between various H1 devices. A device description (DD) file is a driver file used by the Host System to communicate with the H1 devices via the linking device and controllers (PLC or DCS). Each H1 device comes with different versions of DD files. The DD files provide information about virtual communication relationships (VCR) among the host system, H1 device and linking device. Host system software reads the VCR information from DD files provided by manufacturer for communicating with the H1 devices. DD files are typically in a binary format, from which H1 device functionality and block data can be extracted.

Currently, the user has to go through the specification sheet of the H1 device and linking device to know the number of available VCRs that are available to configure the system in the field. There is no easy way for the user to know about the VCRs that have been consumed by the current configuration and the only way is by counting the number of connections of every function block of the field device, which is a difficult task if there are thousands of devices available in the Fieldbus network. Currently the only time a user is aware that the VCR usage limit has been met is when the VCR usage limit is exhausted. When the VCR usage limit has exceeded a permissible limit, the host system displays a build error, which gives the user information about the VCR limit that has been exceeded.

### BRIEF DESCRIPTION OF THE INVENTION

According to one aspect of the invention, a method for virtual communication relationship extraction, availability determination and validation from a foundation fieldbus DD file is described. The method can include obtaining a number of virtual communication relationships for fieldbus and linking devices coupled to a host system, identifying types of the virtual communication relationships for the fieldbus and linking devices, configuring function blocks related to the fieldbus and linking devices, reporting a count of consumed virtual communication relationships and available virtual communication relationships for the fieldbus and linking devices, determining an availability of a total number of virtual communication relationships and in response to no availability of virtual communication relationships, generating a message on the host system.

According to another aspect of the invention, a computer program product for virtual communication relationship extraction, availability determination and validation from a foundation fieldbus DD file is described. The computer program product includes a computer readable medium having instructions for causing a computer to implement a method, the method including obtaining a number of virtual communication relationships for fieldbus and linking devices coupled to a host system, identifying types of the virtual communication relationships for the fieldbus and linking devices, configuring function blocks related to the fieldbus and linking devices, reporting a count of consumed virtual communication relationships and available virtual communication relationships for the fieldbus and linking devices, determining an availability of a total number of virtual communication relationships and in response to no availability of virtual communication relationships, generating a message on the host system.

According to yet another aspect of the invention, a system for virtual communication relationship extraction, availability determination and validation from a foundation fieldbus DD file is described. The system can include a processor configured to obtain a number of permanent and configurable virtual communication relationships for fieldbus and linking devices coupled to a host system, from the DD file, identify types of the virtual communication relationships for the fieldbus and linking devices, configure function blocks related to the fieldbus and linking devices, report a count of consumed virtual communication relationships and available virtual communication relationships for the fieldbus and linking devices, generate a report including a total number of virtual communication relationships, and a number of virtual communication relationships that have been consumed, generate warnings related to consuming virtual communication relationships, determine if a sum of consumed virtual communication relationships and available virtual communication relationships is greater an a total number of virtual communication relationships for the fieldbus devices and the linking devices and in response to no availability of virtual communication relationships, generate a message on the host system that there are no available virtual communication relationships.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a high level block diagram of an exemplary system for VCR extraction, availability determination and validation from foundation fieldbus DD files.

FIG. 2 illustrates a system for VCR extraction, availability determination and validation from foundation fieldbus DD files, illustrating a generalized exemplary controller.

FIG. 3 illustrates a flowchart of a method for VCR extraction, availability determination and validation from foundation fieldbus DD files in accordance with exemplary embodiments.

The detailed description explains embodiments of the invention, together with advantages and features, by way of example with reference to the drawings.

### DETAILED DESCRIPTION OF THE INVENTION

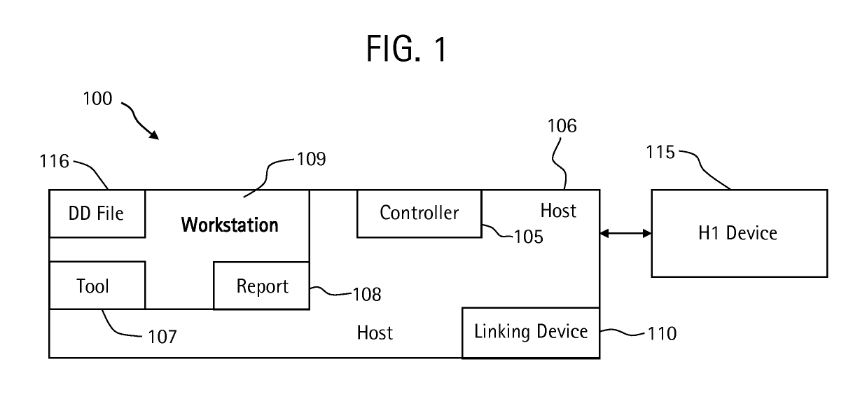

FIG. 1 illustrates a high level block diagram of an exemplary system 100 for virtual communication relationship (VCR) extraction, availability determination and validation from foundation fieldbus DD files. As described herein, the system 100 can include a controller 105, and a workstation 109 included in a host system 106. The controller 105 is coupled to a linking device 110 that provides an interface between the controller 105 and an H1 device 115. The workstation 109 has a configuration for the controller 105, the linking device 110 and the H1 device 115. In addition, the workstation 109 includes a DD file 116. As described herein, the controller 105 can be any control hardware such as PLC and DCS controllers. The controller 105 can also be any suitable hardware controller. The host system 106 is implemented to configure and develop application logic that is downloaded to the controller 105. In exemplary embodiments, the host system 106 supports foundation fieldbus technology and implements an exemplary tool 107 to generate a comprehensive report 108 to display all the VCR information including the VCR type and the number of VCRs available for a particular device (e.g., the H1 device 115). The DD file 116 is provided by the device manufacturer and has a series of information in a binary format which is processed by host system 106 in order to monitor and control the H1 device 115. The DD file 116 includes all information about the VCR. Currently, there are several kinds of VCRs defined in foundation fieldbus: the client/server VCR type; the report distribution VCR type; and the publisher/subscriber VCR type. The exemplary systems and methods described herein contemplate that other VCR types are possible. The publisher/subscriber VCR type is used by the H1 device 115 and linking device 110 for cyclic, scheduled, publishing of user application function block inputs and outputs such as the process variable (PV) and primary output (OUT) on the fieldbus. Each fieldbus device (e.g., the H1 device 115) comes with permanent VCRs and VCRs that are configurable by the host system 106. For every block link across the devices and between device and host (such as between the host system 106 and the H1 device) implements one link object and one VCR. Alerts generated in a fieldbus system such as the system 100 also implement VCRs. Therefore, if a device has a ‘large’ number of blocks then that device should also have ‘large’ number of VCRs. As such, devices should have corresponding numbers of blocks and VCRs. In exemplary embodiments, the systems and methods described herein extract the VCR information from the DD File 116 of a configured fieldbus network (e.g., the system 100) via the tool and display the information in the report 108 that assists the end user in data validation. As described herein, the VCR information includes VCR type, quantity of VCRs available for a given device, and a calculation of used VCRs in the particular fieldbus network.

In exemplary embodiments, the systems and methods described herein can embed a validation rule into the host system 106. The rule can inform the user if a VCR limitation has been reached. The user can also implement this feature to make a study of the consumed VCRs and available VCRs for every device in a fieldbus network (e.g., the system), so that the user can optimize the usage of the fieldbus devices without compromising the speed of the network. As such, the report 108 can show the VCR information for all the field devices and the linking device in the Fieldbus network. The systems and methods described herein can also validate an existing configuration to prevent or inform a user if the maximum VCR limits have been reached.

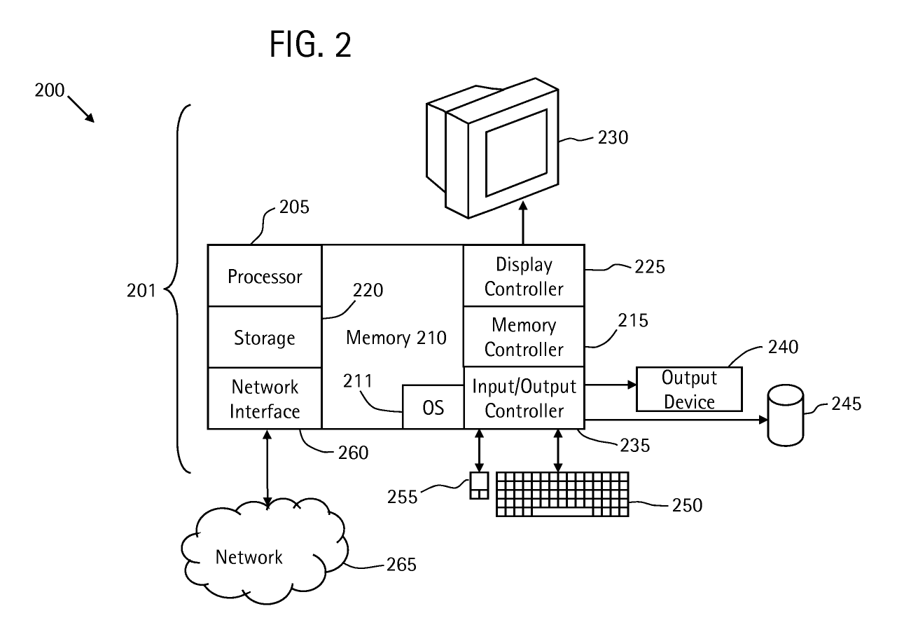

As described herein, the controller 105 can be any suitable hardware for controlling the system 100. FIG. 2 illustrates a system 200 VCR extraction, availability determination and validation from foundation fieldbus DD files, illustrating a generalized exemplary controller. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 200 therefore includes general-purpose computer 201.

In exemplary embodiments, in terms of hardware architecture, as shown in FIG. 2, the computer 201 includes a processor 205, memory 210 coupled to a memory controller 215, and one or more input and/or output (I/O) devices 240, 245 (or peripherals) that are communicatively coupled via a local input/output controller 235. The input/output controller 235 can be, but is not limited to, one or more buses or other wired or wireless connections, as is known in the art. The input/output controller 235 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 205 is a hardware device for executing software, particularly that stored in memory 210. The processor 205 can be any custom made or commercially available processor, a central processing unit (CPU), an auxiliary processor among several processors associated with the computer 201, a semiconductor based microprocessor (in the form of a microchip or chip set), a macroprocessor, or generally any device for executing software instructions.

The memory 210 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 210 may incorporate electronic, magnetic, optical, and/or other types of storage media. Note that the memory 210 can have a distributed architecture, where various components are situated remote from one another, but can be accessed by the processor 205.

The software in memory 210 may include one or more separate programs, each of which comprises an ordered listing of executable instructions for implementing logical functions. In the example of FIG. 2, the software in the memory 210 includes the VCR extraction, availability determination and validation methods (including the tool 107 and report 108 from FIG. 1) described herein in accordance with exemplary embodiments and a suitable operating system (OS) 211. The OS 211 essentially controls the execution of other computer programs, such the VCR extraction, availability determination and validation systems and methods as described herein, and provides scheduling, input-output control, file and data management, memory management, and communication control and related services.

The VCR extraction, availability determination and validation methods described herein may be in the form of a source program, executable program (object code), script, or any other entity comprising a set of instructions to be performed. When a source program, then the program needs to be translated via a compiler, assembler, interpreter, or the like, which may or may not be included within the memory 210, so as to operate properly in connection with the OS 211. Furthermore, the VCR extraction, availability determination and validation methods can be written as an object oriented programming language, which has classes of data and methods, or a procedure programming language, which has routines, subroutines, and/or functions.

In exemplary embodiments, a conventional keyboard 250 and mouse 255 can be coupled to the input/output controller 235. Other output devices such as the I/O devices 240, 245 may include input devices, for example but not limited to a printer, a scanner, microphone, and the like. Finally, the I/O devices 240, 245 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices can include the linking device 110 and the H1 device 115 from FIG. 1. The system 200 can further include a display controller 225 coupled to a display 230. In exemplary embodiments, the system 200 can further include a network interface 260 for coupling to a network 265. The network 265 can be an IP-based network for communication between the computer 201 and any external server, client and the like via a broadband connection. The network 265 transmits and receives data between the computer 201 and external systems. In exemplary embodiments, network 265 can be a managed IP network administered by a service provider. The network 265 may be implemented in a wireless fashion, e.g., using wireless protocols and technologies, such as WiFi, WiMax, etc. The network 265 can also be a packet-switched network such as a local area network, wide area network, metropolitan area network, Internet network, or other similar type of network environment. The network 265 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 201 is a PC, workstation, intelligent device or the like, the software in the memory 210 may further include a basic input output system (BIOS) (omitted for simplicity). The BIOS is a set of essential software routines that initialize and test hardware at startup, start the OS 211, and support the transfer of data among the hardware devices. The BIOS is stored in ROM so that the BIOS can be executed when the computer 201 is activated.

When the computer 201 is in operation, the processor 205 is configured to execute software stored within the memory 210, to communicate data to and from the memory 210, and to generally control operations of the computer 201 pursuant to the software. The VCR extraction, availability determination and validation methods described herein and the OS 211, in whole or in part, but typically the latter, are read by the processor 205, perhaps buffered within the processor 205, and then executed.

When the systems and methods described herein are implemented in software, as is shown in FIG. 2, the methods can be stored on any computer readable medium, such as storage 220, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the VCR extraction, availability determination and validation methods are implemented in hardware, the VCR extraction, availability determination and validation methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

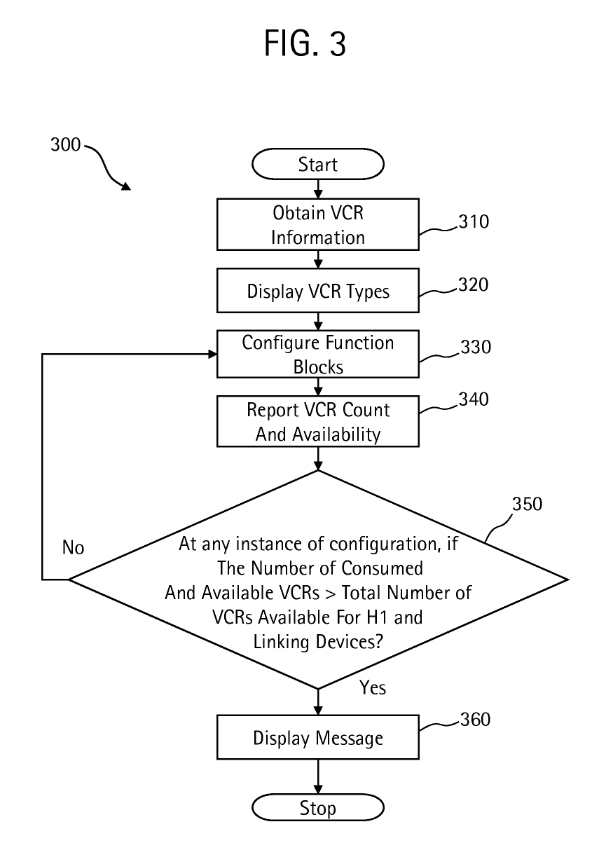

FIG. 3 illustrates a flowchart of a method for VCR extraction, availability determination and validation from foundation fieldbus DD files in accordance with exemplary embodiments. At block 310, the host system 106 obtains the number of permanent and configurable VCRs for the H1 device 115 and the linking device 100. At block 320, the host system 106 displays (which can be both in the report 108 and on a visual display) all the VCR types to the user. As described herein, the types can include the client/server VCR type VCRs for the fieldbus devices and linking devices in the system 100, the publisher/subscriber VCR types (which includes configurable and permanent VCRs) VCRs for the fieldbus devices and linking devices in the system 100, and the report distribution VCR type VCRs for the fieldbus devices and linking devices in the system 100. At block 330, the host system 106 configures the function blocks between the host system 106 and the fieldbus device (e.g., the H1 device) and between fieldbus devices in the system 100. At block 330, the host system 106 also configures the function blocks between multiple fieldbus devices across different linking devices. At block 340, the host system 106 reports the count of consumed VCRs and available VCRs for the fieldbus and linking devices in the system 100. At block 350, the host system 106 determines at any instance of configuration, if the number of consumed VCRs and available VCRs is greater than the total number of VCRs available for fieldbus and linking devices as originally determined from the DD files. If the number of consumed VCRs and available VCRs is not greater than the total number of VCRs available for fieldbus and linking devices, then the method 300 continued at block 330. If the number of consumed VCRs and available VCRs is greater than the total number of VCRs available for fieldbus and linking devices, then at block 360, the host system 106 displays a message that all available VCRs are consumed for the fieldbus and linking devices. In this way, a user knows that all VCRs are consumed without having to continue configuring the system in a false reliance that there are VCRs available.

Technical effects include but are not limited to providing an analysis and guidance to a user in the form of a graphical representation in a report about total number of available VCR's and how many of the VCRs are already consumed for each of the device in the Fieldbus network. The systems and methods described herein can also help in monitoring the changes in network speed caused due to using any additional VCRs by issuing appropriate warnings as the from time to time. The systems and methods described herein can help a user in knowing in advance the available VCRs information for the fieldbus device and linking device, which reduces the effort required to manually calculate this information.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for virtual communication relationship extraction, availability determination and validation from a foundation fieldbus device descriptor (DD) file, the method comprising:
obtaining the number of VCRs defined/available for fieldbus and linking devices coupled to a host system;
identifying types of the VCRs for the fieldbus and linking devices;
reporting a count of consumed VCRs and available VCRs for the fieldbus and linking devices;
determining an availability of a total number of VCRs in the system; and
in response to no availability of VCRs, generating a message on the host system.

2. The method as claimed in claim 1 wherein the number of VCRs for fieldbus and linking devices coupled to the host system is extracted from the DD file.

3. The method as claimed in claim 2 wherein the number of VCRs for fieldbus and linking devices coupled to a host system includes permanent VCRs and configurable VCRs.

4. The method as claimed in claim 1 wherein the types of VCRs are at least one of client/server VCRs, publisher/subscriber VCRs and report distribution VCRs.

5. The method as claimed in claim 1 wherein the function blocks are configured between the host system and the fieldbus devices, between two or more fieldbus devices on at least one of a single linking device and across multiple linking devices.

6. The method as claimed in claim 1 wherein at any instance of configuration, determining the availability of the total number of VCRs, which comprises the sum of consumed VCRs and available VCRs is greater than the total number of VCRs available for the fieldbus devices and the linking devices as originally determined from the DD files.

7. The method as claimed in claim 1 further comprising generating a report including a total number of VCRs, and a number of VCRs that have been consumed

8. The method as claimed in claim 1 further comprising generating warnings related to consuming VCRs.

9. The method as claimed in claim 1 wherein the message indicates that there are no available VCRs.

10. A computer program product for virtual communication relationship extraction, availability determination and validation from a foundation fieldbus device descriptor (DD) file, the computer program product including a computer readable medium having instructions for causing a computer to implement a method, the method comprising:
obtaining the number of VCRs defined/available for fieldbus and linking devices coupled to a host system;
identifying types of the VCRs for the fieldbus and linking devices;
reporting a count of consumed VCRs and available VCRs for the fieldbus and linking devices;
determining an availability of a total number of VCRs in the system; and
in response to no availability of VCRs, generating a message on the host system.

11. The computer program product as claimed in claim 10 wherein the number of VCRs for fieldbus and linking devices coupled to the host system is extracted from the DD file.

12. The computer program product as claimed in claim 11 wherein the number of VCRs for fieldbus and linking devices coupled to a host system includes permanent VCRs and configurable VCRs.

13. The computer program product as claimed in claim 10 wherein the types of VCRs are at least one of client/server VCRs, publisher/subscriber VCRs and report distribution VCRs.

14. The computer program product as claimed in claim 10 wherein the function blocks are configured between the host system and the fieldbus devices, between two or more fieldbus devices on at least one of a single linking device and across multiple linking devices.

15. The computer program product as claimed in claim 10 wherein at any instance of configuration, determining the availability of the total number of VCRs, which comprises the sum of consumed VCRs and available VCRs is greater than the total number of VCRs available for the fieldbus devices and the linking devices as originally determined from the DD files.

16. The computer program product as claimed in claim 10 wherein the method further comprises generating a report including a total number of VCRs, and a number of VCRs that have been consumed

17. The computer program product as claimed in claim 10 wherein the method further comprises generating warnings related to consuming VCRs.

18. The computer program product as claimed in claim 10 wherein the message indicates that there are no available VCRs.

19. A system for virtual communication relationship extraction, availability determination and validation from a foundation fieldbus device descriptor (DD) file, the system comprising:
A processor configured to:
obtain the number of VCRs defined/available for fieldbus and linking devices coupled to a host system;
identify types of the VCRs for the fieldbus and linking devices;
report a count of consumed VCRs and available VCRs for the fieldbus and linking devices;
generate a report including a total number of VCRs, and a number of VCRs that have been consumed;
generate warnings related to consuming VCRs;
determine if a sum of consumed VCRs and available VCRs is greater an a total number of VCRs for the fieldbus devices and the linking devices; and
in response to no availability of VCRs, generate a message on the host system that there are no available VCRs.

20. The system as claimed in claim 1 wherein the function blocks are configured between the host system and the fieldbus devices, between two or more fieldbus devices on at least one of a single linking device and across multiple linking devices.
